(19) United States
(12) Patent Application Publication
(10) Pub. No.: US 2006/0209965 A1
(43) Pub. Date: Sep. 21, 2006

(54) Method and system for fast run-level encoding

(76) Inventor: Hsien-Chih Tseng, San Jose, CA (US)

Correspondence Address: MCANDREWS HELD & MALLOY, LTD, 500 WEST MADISON STREET, SUITE 3400, CHICAGO, IL, 60661, US

(21) Appl. No.: 11/082,532

(22) Filed: Mar. 17, 2005

(51) Int. Cl. H04N 11/02; H04B 1/66; H04N 11/04; H04N 7/12

(52) U.S. Cl. 375/240.25; 375/240.23

(57) ABSTRACT

Methods and systems for processing video data utilizing fast RUN-LEVEL encoding are disclosed herein and may comprise detecting sequential video data within a leading portion of decoded video data entries. If the detected sequential video data comprises one or more zero video data entries, a RUN coefficient may be generated utilizing the zero video data entries. In this regard, a RUN coefficient may indicate the number of zero video data entries in the detected sequential video data. If the detected sequential video data comprises one or more non-zero video data entries, a LEVEL coefficient may be generated utilizing the non-zero video data entries. The generating of the RUN and LEVEL coefficients may be executed in a single cycle, thereby increasing the processing speed of RUN-LEVEL encoding.

### RELATED APPLICATIONS

This application makes reference to U.S. patent application Ser. No. 10/854,592 (Attorney Docket No. 14535US02), filed on May 26, 2004, entitled “Context Adaptive Binary Arithmetic Code Decoding Engine,” which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to encoding of video data. More specifically, certain embodiments of the invention relate to a method and system for fast RUN-LEVEL encoding.

### BACKGROUND OF THE INVENTION

As an efficient coding and compression tool, Context Adaptive Binary Arithmetic Coding (CABAC) is used extensively in Advanced Video Coding (AVC), as described in Draft ITU-T Recommendation and Final Draft International Standard of Joint Video Specification (ITU-T Rec. H.264 | ISO/IEC 14496-10 AVC), March 2003. When enabled, all syntax elements below a slice header layer may be-encoded and/or decoded in AVC utilizing a CABAC engine.

After an AVC encoded video bitstream is decoded utilizing, for example, a CABAC engine, the decoded video data may be subsequently encoded into one or more intermediate video formats prior to being decoded again. For example, RUN-LEVEL encoding may be utilized to encode one or more portions, or syntax elements, of a decoded video stream. RUN-LEVEL encoding, however, may significantly reduce the video processing speed and decoding efficiency since only a single syntax element may be encoded during one operation cycle.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for processing video data utilizing fast RUN-LEVEL encoding, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary simplified variable length coding (SVLC) decoder utilizing entropy pre-processor, in accordance with an embodiment of the invention.

FIG. 2 is a block diagram of an exemplary entropy pre-processor utilizing a context adaptive binary arithmetic coding (CABAC) decoding engine, in accordance with an embodiment of the invention.

FIG. 3 is a functional diagram of an exemplary CABAC decoding engine utilizing a RUN-LEVEL converter, in accordance with an embodiment of the invention.

FIG. 4 is a block diagram illustrating memory utilization within an exemplary RUN-LEVEL converter, in accordance with an embodiment of the invention.

FIG. 5 is a block diagram of an exemplary RUN-LEVEL converter, in accordance with an embodiment of the invention.

FIG. 6 is a flow diagram illustrating exemplary steps for processing decoded video data and generating RUN-LEVEL coefficients, in accordance with an embodiment of the invention.

FIG. 7 is a flow diagram illustrating exemplary steps for generating RUN-LEVEL coefficients in a single operating cycle, in accordance with an embodiment of the invention.

### DETAILED DESCRIPTION OF THE INVENTION

Certain aspects of the invention may be found in a method and system for processing video data utilizing fast RUN-LEVEL encoding. An encoded video bitstream may be pre-processed utilizing RUN-LEVEL encoding to achieve simplified decoding. In this regard, an encoded bitstream may be initially decoded utilizing a CABAC engine, for example. The decoded bitstream may then be utilized to generate a plurality of RUN-LEVEL coefficients, which may be encoded utilizing simplified variable length coding (SVLC), for example. The SVLC-encoded bitstream may then be decoded utilizing an SVLC decoder.

Aspects of the method may comprise detecting sequential video data within a leading portion of decoded video data entries. If the detected sequential video data comprises one or more zero video data entries, a RUN coefficient may be generated utilizing the zero video data entries. In this regard, a RUN coefficient may indicate the number of zero video data entries in the detected sequential video data. If the detected sequential video data comprises one or more non-zero video data entries, a LEVEL coefficient may be generated utilizing the non-zero video data entries. The generating of the RUN and LEVEL coefficients may be executed in a single cycle, thereby increasing the processing speed of RUN-LEVEL encoding.

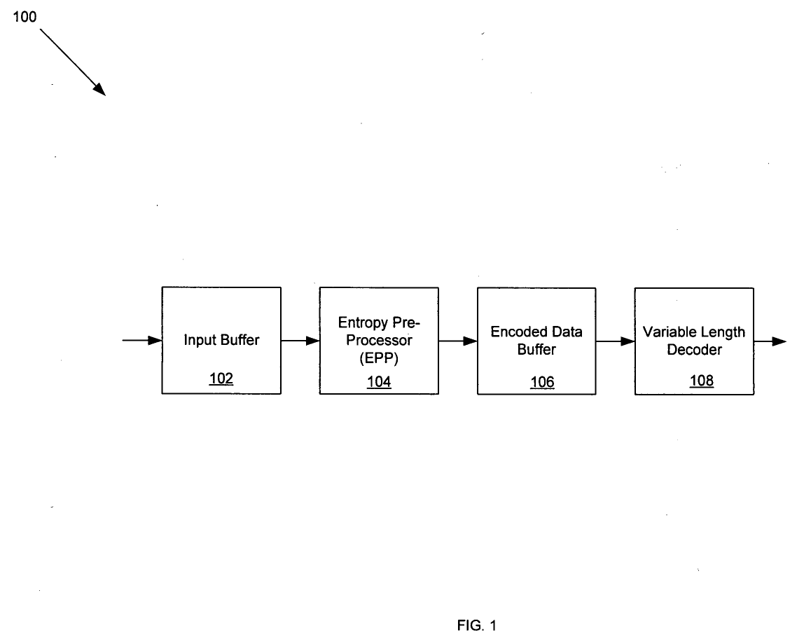

FIG. 1 is a block diagram of an exemplary simplified variable length coding (SVLC) decoder utilizing entropy pre-processor, in accordance with an embodiment of the invention. Referring to FIG. 1, the SVLC decoder 100 may comprise an input buffer 102, an entropy pre-processor (EPP) 104, an encoded data buffer 106, and a variable length decoder 108.

The EPP 104 may comprise suitable circuitry and/or logic and may be adapted to decode video data which was encoded utilizing one or more video encoding standards, such as advanced video coding (AVC) and/or variable length coding (VLC) standards. For example, the EPP 104 may be adapted to decode video data encoded by AVC's context adaptive binary arithmetic coding (CABAC) or context adaptive variable length coding (CAVLC) standards, as well as by VLC's MPEG-2 or VC-9 standards.

After an encoded bitstream is decoded by the EPP 104, the EPP 104 may be adapted to convert, or encode, a decoded bitstream to a simplified video format for subsequent video processing. In an exemplary aspect of the invention, the EPP 104 may be adapted to convert a decoded bitstream to a simplified variable length coding (SVLC) format suitable for subsequent decoding by, for example, a variable length decoder. During SVLC encoding, the EPP 104 may convert decoded video data to one or more RUN-LEVEL coefficient pairs, where each RUN-LEVEL coefficient pair may be generated in a single cycle.

The input buffer 102 and the encoded data buffer 106 may be utilized at the input and the output of the EPP 104, respectively. In this regard, the EPP 104 may operate at an average, or transmitted, data rate, while allowing decoding operations within the EPP 104 to be performed at the instantaneous processing data rates characteristic of real-time decoding. The variable length decoder 108 may comprise suitable circuitry and/or logic and may be adapted to decode video data encoded by a simplified variable length coding format such as SVLC.

In operation, encoded video data may be initially buffered in the input buffer 102. The EPP 104 may acquire encoded video data from the input buffer 102 and may utilize a CABAC engine, for example, to decode the acquired encoded vide data. In an exemplary aspect of the invention, the CABAC engine within the EPP 104 may comprise a RUN-LEVEL encoder. The RUN-LEVEL encoder may be adapted to generate one or more RUN-LEVEL coefficient pairs utilizing decoded video data. In addition, the RUN-LEVEL decoder may be adapted to generate each RUN-LEVEL coefficient pair in a single cycle. RUN-LEVEL coefficient pairs may then be communicated to an SVLC encoder within the EPP 104 for encoding of the RUN-LEVEL coefficient pairs into simplified variable length coding format such as SVLC. The SVLC encoded stream generated by the EPP 104 may be buffered in the encoded data buffer 106. The buffered SVLC encoded bitstream may then be communicated to the variable length decoder 108 for decoding.

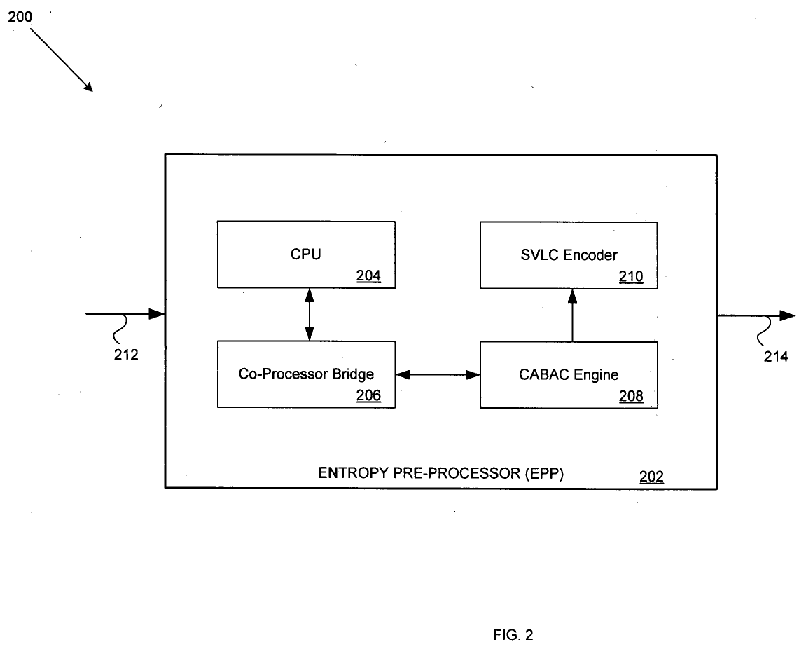

FIG. 2 is a block diagram of an exemplary entropy pre-processor utilizing a context adaptive binary arithmetic coding (CABAC) decoding engine, in accordance with an embodiment of the invention. Referring to FIG. 2, the entropy pre-processor (EPP) 200 may comprise a central processing unit (CPU) 204, a co-processor bridge 206, a CABAC engine 208, and a simple variable length code (SVLC) encoder 210.

In operation, the EPP 202 may acquire encoded video bitstream 212, which may be encoded in accordance with the AVC standard, for example. The encoded bitstream 212 may then be decoded by the CABAC engine 208. In addition, the CABAC engine 208 within the EPP 202 may comprise a RUN-LEVEL encoder, which may be adapted to generate one or more RUN-LEVEL coefficient pairs utilizing decoded video data. Each RUN-LEVEL coefficient pair may be generated in a single cycle and may be communicated to the SVLC encoder 210 for encoding of the RUN-LEVEL coefficient pairs into simplified variable length coding format, such as SVLC.

The CPU 204 may be adapted to issue commands related to the encoded video stream 212 received by the CABAC engine 208. The commands issued by the CPU 204 may be communicated to the CABAC engine 208 via the co-processor bridge 206. After the input video stream 212 is decoded, the SVLC encoded output stream 214 may be communicated outside the EPP 202 for further processing, such as buffering and decoding by a variable length decoder, for example.

In an exemplary aspect of the invention, during decoding of CABAC-coded video bitstream, the CABAC engine 208 may be adapted to perform initialization, binarization, symbol decoding, model update, and/or reference management, for example. During initialization, the CABAC engine 208 may be initialized utilizing already decoded properties related to a portion of video information such as a slice. Range division variables and/or context model variables utilized in the decoding engine may be initialized to known values. During binarization, each syntax element to be decoded may be expressed in a variable length code at the encoder side. The process of converting a fixed-length code to a variable length code is called binarization. By utilizing binarization within a CABAC encoder, a string of bits may be assigned to syntax elements with more than two possible values. In addition, shorter codes may be assigned to the more probable values for the syntax element. During decoding of a CABAC-encoded bitstream, a de-binarization process may be applied within the CABAC engine 208 so that the original fixed-length syntax element may be recovered.

The basic element of a video stream during decoding by the CABAC engine 208 is a binary bit value of ‘1’ or ‘0’, also referred to as a bin. A binarized syntax element may comprise a string of binary bits, or bins, and each such bit may be referred to as a symbol. Each symbol of a syntax element may be decoded by the CABAC engine 208 individually with a probability model associated with the symbol. In CABAC, a symbol may be characterized by several models, or contexts, associated with it and the model selection may be based on adjacent macroblock properties. After a symbol is decoded by the CABAC engine 208, the probability model, or context model, may be updated based on the decoded value of the symbol. In this regard, an adaptive updating model may be achieved and the next time the same symbol is decoded again using the same context model, the probability values may be different.

During decoding by the CABAC engine 208, context selection for certain binary bits, or bins, in a syntax element may be based on the values of previously decoded syntax elements in geometrically adjacent left and top macroblocks. When adaptive frame-field (AFF) coding is enabled for a bit stream, a macroblock pair may be either frame or field coded. The CABAC engine 208 may utilize a set of rules that may be followed based on the properties of the current macroblock pair and the adjacent macroblock pairs in order to derive the reference value associated with a geometrically adjacent block/macroblock during video bitstream decoding. These references may be utilized to calculate the context associated with the bin-to-be decoded.

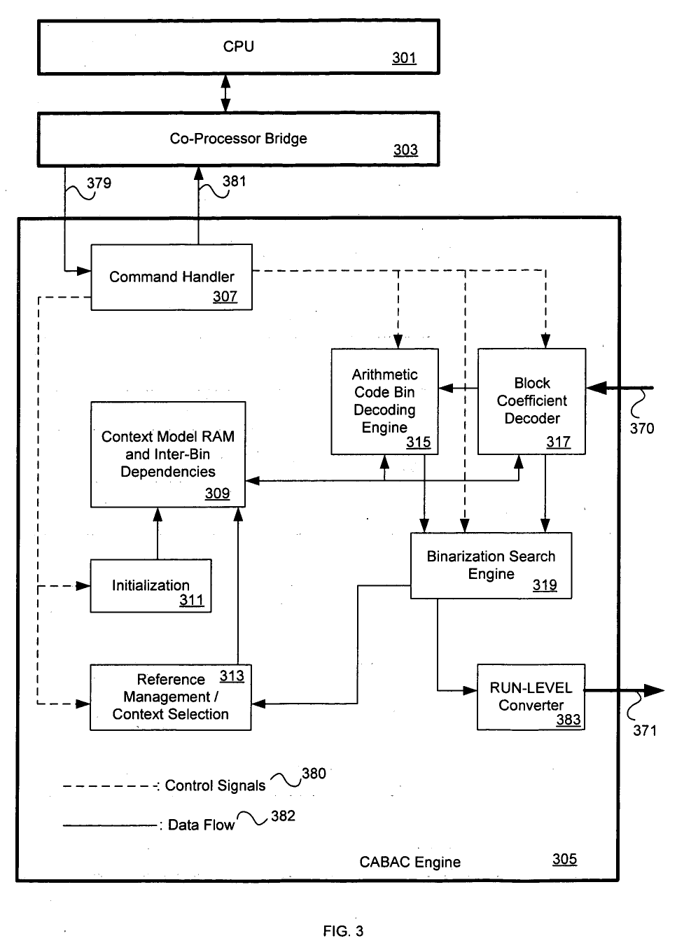

FIG. 3 is a functional diagram of an exemplary CABAC decoding engine utilizing a RUN-LEVEL converter, in accordance with an embodiment of the invention. Referring to FIG. 3, commands 379 may be provided by the CPU 301, which may communicate with the CABAC engine 305 through the co-processor bridge 303. The CPU 301 may be adapted to provide decoding parameters and/or commands for starting the CABAC engine 305. The decoded results may be either returned to the CPU 301 or stored in memory outside the CABAC engine 305 for further processing. The decoded results may be utilized directly by other decoding processes or may be converted into another format, such as a simple variable length code (SVLC) format.

The CABAC engine 305 may comprise a command handler 307, a block coefficient decoder 317, an arithmetic code bin decoding engine (ACBDE) 315, a binarization search engine 319, a reference management and context selection (RMCS) module 313, an initialization module 311, a context model RAM 309, and a RUN-LEVEL converter 383.

The commands 379 issued by the CPU 301 may be received by the command handler 307. The command handler 307 may be adapted to decode the CPU commands 379 and may output control signals 380 to the remaining CABAC engine modules. After processing the command 379, the command handler 307 may provide status information 381 back to the CPU 301. The status information 381 may provide, for example, a confirmation that the command 379 has been executed, a decoded value from the received video stream 370, or both. After the command handler 307 communicates the status 381, it may proceed with receiving the next command from the CPU 301.

The incoming encoded video stream 370 may be communicated to either the block coefficient decoder 317 or to the ACBDE 315. The CPU 301 may determine a class of the elements in the bit stream 370. In order to do that, the CPU 301 may read previously decoded syntax elements. Based on the different classes of syntax elements that are presented in the bit stream 370, the CPU 301 may issue an appropriate command 379, which may activate either the block coefficient decoder 317 or the ACBDE 315. Subsequent initialization on the block coefficient decoder 317 and the ACBDE 315 may be performed by the initialization unit 311. After initialization, bits may be acquired from the incoming encoded bitstream 370, as needed, for decoding. In order to decode the received bits, the block coefficient decoder 317 or to the ACBDE 315 may utilize probability context models stored in the context model RAM 309.

There are 399 probability context models in the current version of the AVC draft standard, which are associated with many syntax elements and bins within them for a given encoded video stream. At the start of a slice, the context model may be initialized using a fixed algorithm for calculating the initial values for the context models, according to the CABAC specification in AVC. Each of the 399 context models may be composed of a “state” value and a Most Probable Symbol (MPS) value (the latter is a single bit), which values may be stored locally in the context model RAM 309. The context model RAM may comprise a static RAM of 399 entries, for example. Since the “state” variable may utilize 6 bits, the context model RAM 309 may comprise 399 entries, each being 7 bits wide.

Each context stored in the context model RAM 309 may be initialized by the initialization module 311 to a preset value that is set as the standard, at the start of the decoding process of a unit of encoded video stream data, such as a slice. As bins from the encoded video stream 370 are received by the CABAC engine 305 and decoded by the ACBDE 315 or the block coefficient decoder 317, the decoded values may be used to modify the context model. Probabilities may then be modified dynamically according to the actual data being communicated. When another subsequent bin from the same class is being decoded, the modified context model is used and, if necessary, a further update to the context model may be performed at that time. This process may continue in the CABAC engine 305 until the end of the entire sequence of encoded bins is reached. At that time, all context models stored in the context model RAM 309 may be reset to a standard preset value.

To increase processing speed for context model initialization, the initialization function may be implemented utilizing a hardwired block, such as the initialization module 311. By utilizing the initialization module 311, a context model may be initialized at the rate of one context every clock cycle.

A core function of the ACBDE module 315 may involve performing the arithmetic-decoding algorithm pursuant to the AVC Standard. The ACBDE module 315 may be adapted to decode a bin using a context model provided as input. The context model may be updated at the end of the decoding process, which may last one cycle. The CABAC internal variables pursuant to the AVC Standard may be maintained inside the ACBDE 315 and may be updated when a bin is decoded. The ACBDE module 315 may be hardwired and may be utilized to support decoding of a generic AVC CABAC syntax element.

If the block coefficient decoder 317 is selected for decoding by the CPU 301, the decoding process speed may be increased as a complete block of coefficients may be decoded using a single command from the CPU 301. This is possible because context selection for all the coefficients within a block may depend only on the macroblock type, the block index, and/or the decoded syntax elements within the macroblock.

Once the bins have been decoded by the block coefficient decoder 317 or the ACBDE 315, the bins may be communicated to the binarization search engine 319, where bins may be converted to the corresponding syntax elements, or symbols. The binarization search engine 319 may work together with the ACBDE 315 and the block coefficient decoder 317 to appropriately terminate the syntax element decoding process by comparing the decoded bins to a set of binarization codes and determining whether a valid code word has been decoded. Each syntax element may have a different set of binarization codes. The binarization search engine 319 may be a hardwired block in order to support a plurality of AVC CABAC syntax element binarization schemes.

In some cases, several decoded bins may be converted by the binarization search engine 319 to only one syntax element. In other cases, only one bin may correspond, and be converted by the binarization search engine 319, to one syntax element. The binarization search engine 319 may be adapted to determine the number of bins that have to be converted for each corresponding class of syntax elements.

After decoding a given bin, the binarization search engine 319 may update the RMCS module 313 with an updated context model for that bin. The binarization search engine 319 may then continue converting the remaining bins for a specific class of a syntax element. After the remaining bins from the specific class have been converted, the binarization search engine 319 may perform one or more updates to the corresponding context model via the RMCS module 313 so that it may be used in subsequent decoding of bins from the same class. The final decoded symbol may be communicated to the RUN-LEVEL converter 383.

The RUN-LEVEL converter 383 may be utilized within the CABAC engine 305 to generate one or more RUN-LEVEL coefficient pairs utilizing a decoded bitstream acquired from the binarization search engine 319. After RUN-LEVEL coefficients are generated by the RUN-LEVEL converter 383, RUN-LEVEL coefficients may be communicated as an output signal 371 outside the CABAC engine 305. For example, RUN-LEVEL coefficient output 371 may be communicated to a SVLC encoder for encoding.

The CABAC engine 305 may be adapted to perform decoding in a generic syntax element decoding mode or a group syntax element decoding mode, for example. These modes correspond to different types of commands issued by the CPU 301.

In the generic syntax element mode, the CABAC engine 305 may be adapted to decode and parse one syntax element at a time. This function may utilize the generic or common resource in the engine because all generic syntax elements may be encoded in a similar manner. The CPU 301 may provide the parameters needed by the CABAC engine 305 to decode the expected syntax element. The CABAC engine 305 may then decode the whole syntax element in one command without further involvement from the CPU 301. Consequently, bins associated with that syntax element may be decoded in one hardware operation cycle. The generic syntax element mode may be performed, for example, by an arithmetic code bin decoding engine, such as the ACBDE 315.

In the group syntax element mode, the CABAC engine 305 may be adapted to decode and parse one or more syntax elements utilizing dedicated decoding control logic in addition to the common resource utilized for decoding generic syntax elements. The CPU 301 may provide the parameters needed by the CABAC engine 305 to enable decoding without the intervention by the CPU 301. The group syntax element-decoding mode may involve decoding of multiple syntax elements by the CABAC engine 305 in response to one command from the CPU 301. Some of these syntax elements may be present only in the previously decoded syntax elements having certain specific values. This condition check may be performed by the CABAC engine 305. The group syntax element mode may be performed, for example, by a block coefficient decoder, such as the block coefficient decoder 317.

The syntax elements in the encoded video stream 370, whether they are decoded using the generic syntax element decoding mode or the group syntax element decoding mode, may be classified into various categories. Exemplary categories may comprise syntax elements without inter-bin dependencies and syntax elements with inter-bin dependencies.

The category of syntax elements without inter-bin dependencies does not have inter-bin dependencies. That is, the context selection of the succeeding bins of this type of syntax element does not depend on the already decoded bins. Typically in this case, there may be multiple contexts to select from for the first bin, and there may be only one possible context for each of the other bins. In the AVC standard, the syntax elements that fall into this category may be represented by the following elements, defined in the AVC specification:
mb_skip
sub_mb_type_P
abs_mvd_h
abs_mvd_v
ref_idx
delta_qp
ipred_chroma
coded_block_flag
coeff_sig
coeff_last
Each bin of cbp_luma
Each bin of cbp_chroma
ipred_mpm, ipred_rm

For this type of syntax element, contexts provided in the AVC standard context tables may be re-arranged in such a way that all contexts for the syntax elements listed above may be directed to auto-index to another context and the resulting contexts may be stored in the context model memory 309. The context for the first bin may be calculated by the CABAC engine 305. The CABAC engine 305 may then derive the contexts for other bins for the syntax element using auto-indexing, for example.

The second type of syntax elements is syntax elements with inter-bin dependencies. These syntax elements may possess the properties that contexts for their bins after the first bin cannot be determined until previous bins have been decoded. The syntax elements in the AVC standard that fall into this category may be represented by the following elements defined in the AVC specification:
mb_type_I, mb_type_P and mb_type_B
sub_mb_type_B
coeff_abs_level

Hardwired functions for these syntax elements are similar to the ones without inter-bin dependencies except that the context selections for later bins may be determined by hardware, depending on the decoded values of earlier bins.

There are certain syntax elements, for which multiple contexts may be provided for certain bins and the CABAC engine 305 may determine which context to use. The selection of an appropriate context may be based on previously decoded values in adjacent blocks or macro-blocks. In this regard, the spatially adjacent left and top block, or macro-block values, may be used to calculate the context to be used for the decoding of a bin pursuant to the AVC Standard. For selecting the adjacent block or macro-block, the adaptive frame-field (AFF) properties of the different blocks may need to be considered.

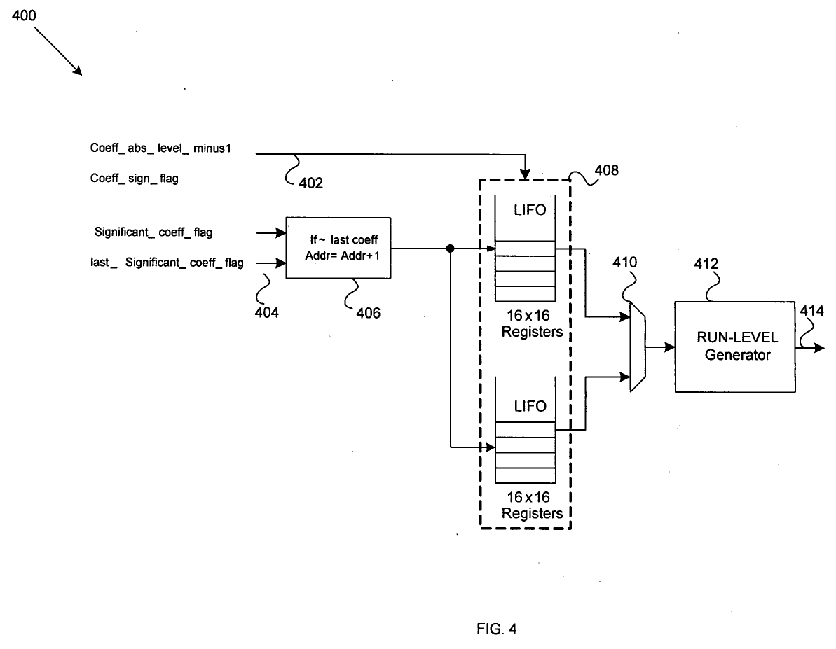

FIG. 4 is a block diagram illustrating memory utilization within an exemplary RUN-LEVEL converter, in accordance with an embodiment of the invention. Referring to FIG. 4, the RUN-LEVEL converter 400 may comprise a memory selector 406, a memory module 408, a multiplexer 410, and a RUN-LEVEL generator 412.

In an exemplary aspect of the invention, the RUN-LEVEL converter 400 may be utilized within a CABAC decoding engine, such as the CABAC decoding engine 305 in FIG. 3. In this regard, the RUN-LEVEL converter 400 may be adapted to acquire decoded syntax elements 402 and 404 as inputs. Syntax elements 402 and 404 may comprise one or more coefficients. For example, syntax element 402 may comprise coefficient coeff_abs_level_minus1 corresponding to a coefficient value and/or coefficient coeff_sign_flag corresponding to a coefficient sign. Syntax elements 404 may comprise coefficient significant_coeff_flag corresponding to a zero/non-zero coefficient indicator and/or coefficient last_significant_coeff_flag corresponding to a flag indicating the last coefficient in a group of coefficients acquired for processing.

The memory selector 406 may comprise suitable circuitry, logic, and/or code and may be adapted to select between one or more memory registers for storing syntax elements 402 in the memory module 408. The memory module 408 may comprise one or more memories for storing acquired decoded syntax elements. For example, the memory module 408 may comprise two last-in-first-out (LIFO) memories, where each LIFO memory may comprise 16 memory registers, each 16 bits wide. In one aspect of the invention, the RUN-LEVEL converter 400 may be adapted to store 16 coefficients in one LIFO memory in the memory module 408. The 16 coefficients may be acquired as a single block coefficient from, for example, a binarization search engine within a CABAC decoding engine, such as the binarization search engine 319 in the CABAC decoding engine 305 illustrated in FIG. 3.

Even though the memory module 408 comprises two LIFO memories, the present invention is not so limited. Accordingly, other types of memory modules may also be utilized within the RUN-LEVEL converter 400. In addition, a different number of memory modules may also be utilized for storage of block coefficients prior to RUN-LEVEL coefficient generation.

The multiplexer 410 may be adapted to acquire coefficients from within the memory module 408 and to output a single 16-bit coefficient entry to the RUN-LEVEL generator 412. The RUN-LEVEL generator 412 may comprise suitable circuitry and/or logic and may be adapted to acquire one or more coefficients from the multiplexer 410 and generate one or more RUN-LEVEL coefficient pairs 414 as an output.

In operation, decoded syntax elements 402 may be stored in the memory module 408. Syntax elements 404 may be communicated to the memory selector 406. The memory selector 406 may be adapted to select a memory register location within the memory module 408 for storing a decoded syntax element 402. The decoded syntax element 402 may comprise a plurality of coefficients, such as a block coefficient. The multiplexer 410 may be adapted to select one or more coefficients from the memory module 408 and communicate the selected coefficients to the RUN-LEVEL generator 412 for processing. The RUN-LEVEL generator 412 may acquire the coefficients from the multiplexer 410 and may generate one or more pairs of RUN-LEVEL coefficients 414. Each RUN-LEVEL coefficient pair may be generated in one operation cycle and may be subsequently utilized by a SVLC encoder, for example, to generate an encoded video stream.

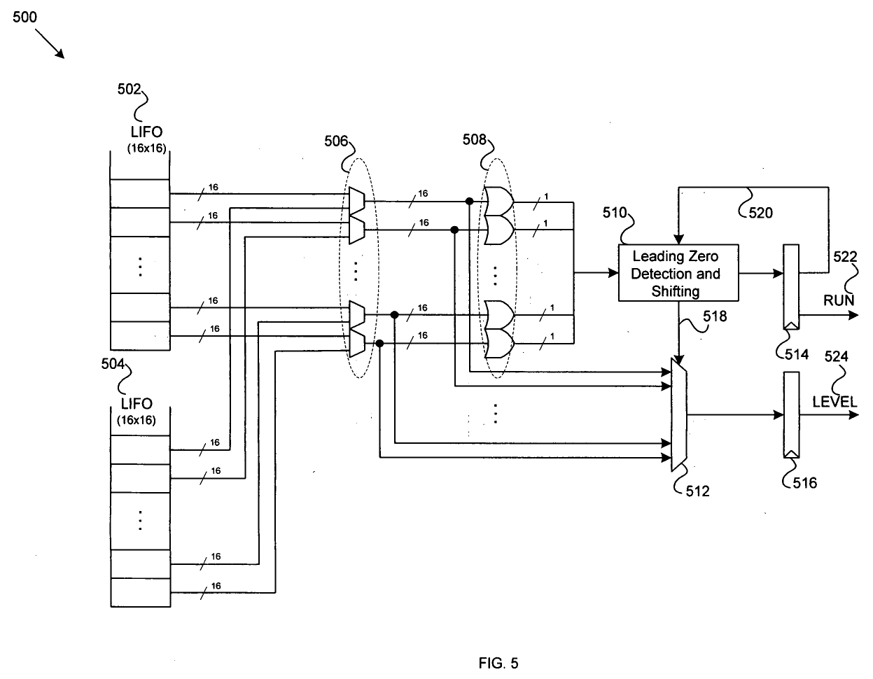

FIG. 5 is a block diagram of an exemplary RUN-LEVEL converter, in accordance with an embodiment of the invention. Referring to FIG. 5, the RUN-LEVEL converter 500 may comprise memory modules 502 and 504, a plurality of multiplexers 506, a plurality of OR gates 508, a leading zero detection and shifting (LZDS) module 510, a multiplexer 512, and buffers 514 and 516.

The memory modules 502 and 504 may comprise last-in-first-out (LIFO) memories, where each LIFO memory may comprise 16 memory registers, each 16 bits wide. The memory modules 502 and 504 may be utilized for storing acquired decoded syntax elements. In one aspect of the invention, the RUN-LEVEL converter 500 may be adapted to store 16 coefficients in each of the memories 502 and 504. Even though the RUN-LEVEL converter 500 utilizes two. LIFO memories 502 and 504, the present invention is not so limited. Other types of memory modules may also be utilized within the RUN-LEVEL converter 500. In addition, a different number of memory modules may also be utilized for storage of block coefficients prior to RUN-LEVEL coefficient generation.

The plurality of multiplexers 506 may be adapted to select as inputs coefficients stored in corresponding memory registers within memories 502 and 504. In this regard, memories 502 and 504 may be utilized in a “ping-pong” fashion and coefficients may be selected for processing from one memory while, at the same time, subsequent decoded coefficients may be stored in the second memory. Each of the multiplexers from the plurality of multiplexers 506 may be adapted to communicate a 16-bit coefficient entry to an OR gate from the plurality of OR gates 508.

Each of the plurality of OR gates 508 may be adapted to OR a coefficient, or a decoded video data entry acquired from a corresponding multiplexer within the plurality of multiplexers 506. Each of the plurality of OR gates 508 may then output, for example, a 1-bit flag indicating whether the ORed video data entry comprises a zero data entry or a non-zero data entry. For example, an OR gate output of logic 1 may indicate non-zero data entry at the input of the corresponding OR gate, and an output of logic 0 may indicate a zero data entry at the input of the OR gate. The plurality of decoded coefficients may be communicated to the multiplexer 512, prior to being ORed by the plurality of OR gates 508.

The LZDS module 510 may comprise suitable circuitry and/or logic and may be adapted to detect one or more zero data entries within one or more coefficients communicated to the plurality of OR gates 508. For example, the LZDS module 510 may be adapted to detect one or more logic 0 outputs from the outputs of the plurality of OR gates 508. An indicator of how many logic 0 outputs are detected may then be stored in the buffer 514 prior to being outputted as a RUN coefficient 522. After a RUN coefficient is generated and outputted, a shift command 520 may be communicated back to the LZDS module 510 so that the outputs from the plurality of OR gates 508 may be shifted by a corresponding number of entries.

The LZDS module 510 may also communicate an indicator 518 to the multiplexer 512. The indicator 518 may be utilized by the multiplexer 512 to output a subsequent non-zero data entry following one or more zero data entries represented by a RUN coefficient. The non-zero data entry may then be communicated from the multiplexer 512 and stored in the buffer 516, prior to being communicated out as a LEVEL coefficient 524. In an exemplary aspect of the invention, the generation of the RUN and LEVEL coefficients may be achieved in a single operating cycle.

In operation, decoded syntax elements, or coefficients, may be stored in a “ping-pong” fashion in memories 502 and 504. The decoded syntax elements may comprise a plurality of coefficients, such as a block coefficient. Each of the plurality of multiplexers 506 may be adapted to select one or more coefficients from memory registers within memory 502 and/or 504, and communicate the selected coefficients to a corresponding OR gate in the plurality of OR gates 508. Each of the OR gates may be adapted to OR a coefficient, or a decoded video data entry acquired from a corresponding multiplexer within the plurality of multiplexers 506. Each of the plurality of OR gates 508 may then output a 1-bit flag indicating whether the ORed video data entry comprises a zero data entry or a non-zero data entry. The plurality of decoded coefficients may be communicated to the multiplexer 512, prior to being ORed by the plurality of OR gates 508.

The LZDS module 510 may detect one or more zero data entries within one or more coefficients communicated to the plurality of OR gates 508. For example, the LZDS module 510 may be adapted to detect one or more logic 0 outputs from the outputs of the plurality of OR gates 508. An indication of how many logic 0 outputs are detected may then be stored in the buffer 514 prior to being outputted as a RUN coefficient 522. After a RUN coefficient is generated and outputted, a shift command 520 may be communicated back to the LZDS module 510 so that the outputs from the plurality of OR gates 508 may be shifted by a corresponding number of entries. The LZDS module 510 may also communicate an indicator 518 to the multiplexer 512. The multiplexer 512 may then output a subsequent non-zero data entry following one or more zero data entries represented by a RUN coefficient. The non-zero data entry may then be communicated from the multiplexer 512 and stored in the buffer 516, prior to being communicated out as a LEVEL coefficient 524.

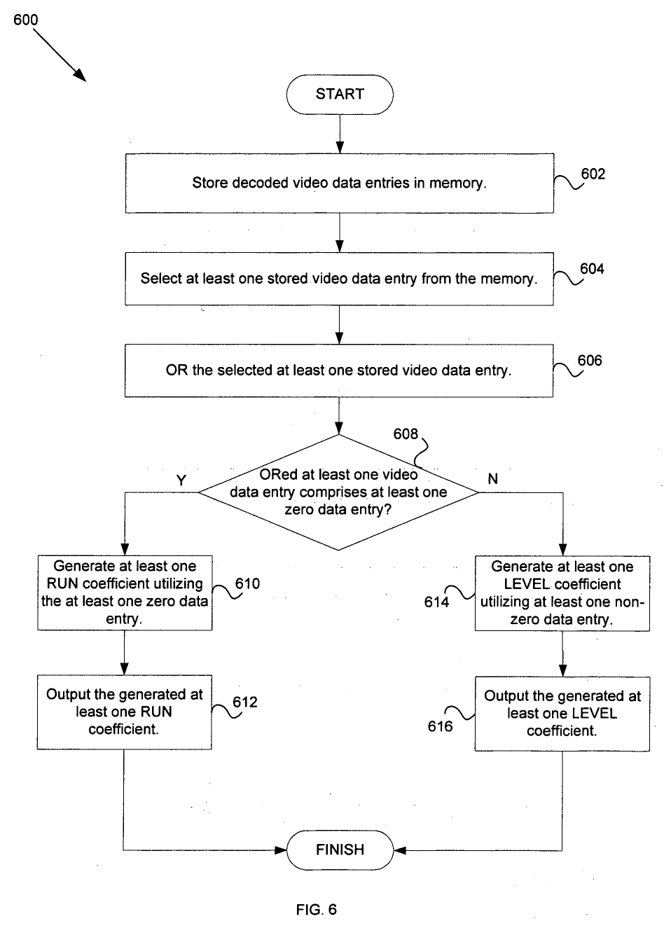

FIG. 6 is a flow diagram illustrating exemplary steps for processing decoded video data and generating RUN-LEVEL coefficients, in accordance with an embodiment of the invention. Referring to FIG. 6, at 602, decoded video data entries may be stored in memory. At 604, one or more stored video data entries may be selected from memory. At 606, the selected video data entries may be ORed utilizing a plurality of OR gates, for example. At 608, it may be determined whether the ORed video data entries comprise one or more zero data entries. If the ORed video data entries comprise one or more zero data entries, at 610, a RUN coefficient may be generated utilizing the one or more zero data entries. At 612, the generated RUN coefficient may be communicated as an output. If the ORed video data entries do not comprise one or more zero data entries, at 614, a LEVEL coefficient may be generated utilizing at least one non-zero data entry. At 616, the generated LEVEL coefficient may be communicated as an output.

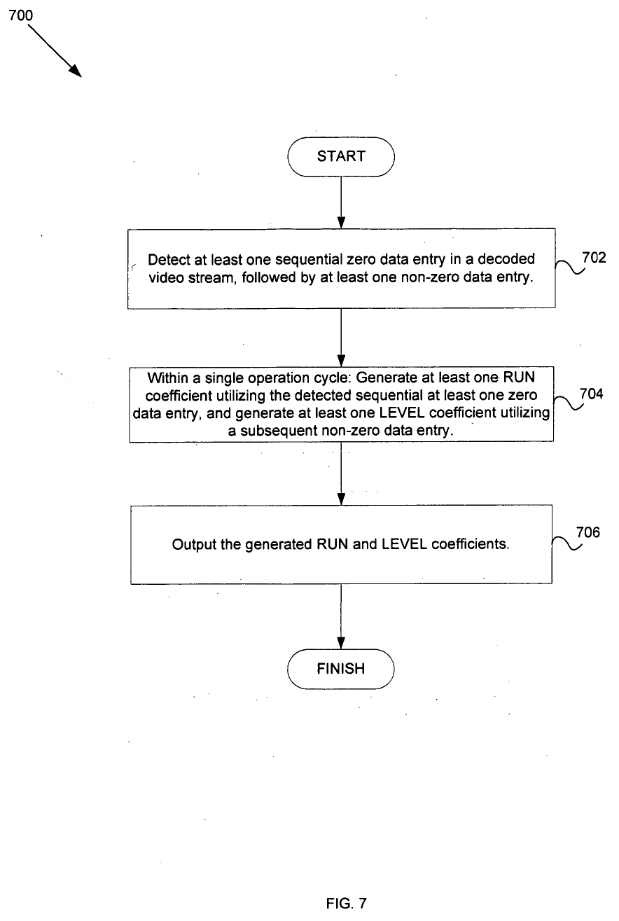

FIG. 7 is a flow diagram illustrating exemplary steps for generating RUN-LEVEL coefficients in a single operating cycle, in accordance with an embodiment of the invention. Referring to FIG. 7, at 702, at least one sequential zero data entry may be detected in a decoded video stream. The sequential zero data entry may be followed by one or more non-zero data entries. At 704, a RUN coefficient may be generated utilizing the detected sequential zero data entry and a LEVEL coefficient may be generated utilizing a subsequent non-zero data entry. The generation of the RUN and LEVEL coefficients may be achieved in a single operation cycle. At 706, the generated RUN and LEVEL coefficients may be outputted for subsequent processing.

Accordingly, aspects of the invention may be realized in hardware, software, firmware or a combination thereof. The invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for processing video data, the method comprising:
detecting at least one sequential video data entry within a leading portion of a plurality of decoded video data entries;
generating at least one RUN coefficient utilizing at least one sequential zero data entry in said leading portion, if said detected at least one sequential video data entry comprises at least one zero video data entry; and
generating at least one LEVEL coefficient utilizing at least one sequential non-zero data entry in said leading portion, if said detected at least one sequential video data entry comprises at least one non-zero video data entry, wherein said generating of said at least one RUN coefficient and said generating of said at least one LEVEL coefficient are executed in a single cycle.

2. The method according to claim 1, wherein said generated at least one RUN coefficient comprises a first indication of a number of said at least one sequential zero data entry in said leading portion.

3. The method according to claim 1, wherein said generated at least one LEVEL coefficient comprises said at least one sequential non-zero data entry.

4. The method according to claim 1, wherein at least one of said plurality of decoded video data entries comprises at least one of a coeff_sign_flag syntax element, a coeff_abs_level_minus1 syntax element, a significant_coeff_flag syntax element, and a last_significant_coeff_flag syntax element.

5. The method according to claim 1, further comprising storing said plurality of decoded video data entries in at least one memory.

6. The method according to claim 5, wherein said at least one memory comprises a last-in-first-out (LIFO) memory.

7. The method according to claim 5, further comprising selecting at least one of said stored plurality of decoded video data entries from said at least one memory.

8. The method according to claim 7, further comprising ORing said selected at least one of said stored plurality of decoded video data entries.

9. The method according to claim 8, further comprising detecting at least one zero video data entry among said ORed selected at least one of said stored plurality of decoded video data entries.

10. The method according to claim 9, further comprising shifting a first portion of said ORed selected at least one of said stored plurality of decoded video data entries, wherein said first portion comprises said detected at least one zero video data entry.

11. The method according to claim 9, further comprising detecting at least one non-zero video data entry among a remaining portion of said ORed selected at least one of said stored plurality of decoded video data entries.

12. A system for processing video data, the system comprising:
at least one code generator that detects at least one sequential video data entry within a leading portion of a plurality of decoded video data entries;
said at least one code generator generates at least one RUN coefficient utilizing at least one sequential zero data entry in said leading portion, if said detected at least one sequential video data entry comprises at least one zero video data entry; and
said at least one code generator generates at least one LEVEL coefficient utilizing at least one sequential non-zero data entry in said leading portion, if said detected at least one sequential video data entry comprises at least one non-zero video data entry, wherein said generating of said at least one RUN coefficient and said generating of said at least one LEVEL coefficient are executed in a single cycle.

13. The system according to claim 12, wherein said generated at least one RUN coefficient comprises a first indication of a number of said at least one sequential zero data entry in said leading portion.

14. The system according to claim 12, wherein said generated at least one LEVEL coefficient comprises said at least one sequential non-zero data entry.

15. The system according to claim 12, wherein at least one of said plurality of decoded video data entries comprises at least one of a coeff_sign_flag syntax element, a coeff_abs_level_minus1 syntax element, a significant_coeff_flag syntax element, and a last_significant_coeff_flag syntax element.

16. The system according to claim 12, further comprising at least one processor that stores said plurality of decoded video data entries in at least one memory.

17. The system according to claim 16, wherein said at least one memory comprises a last-in-first-out (LIFO) memory.

18. The system according to claim 16, wherein said at least one processor selects at least one of said stored plurality of decoded video data entries from said at least one memory.

19. The system according to claim 18, further comprising at least one OR gate that ORs said selected at least one of said stored plurality of decoded video data entries.

20. The system according to claim 19, wherein said at least one code generator detects at least one zero video data entry among said ORed selected at least one of said stored plurality of decoded video data entries.

21. The system according to claim 20, wherein said at least one code generator shifts a first portion of said ORed selected at least one of said stored plurality of decoded video data entries, wherein said first portion comprises said detected at least one zero video data entry.

22. The system according to claim 20, wherein said at least one code generator detects at least one non-zero video data entry among a remaining portion of said ORed selected at least one of said stored plurality of decoded video data entries.
